(19) United States
(12) Patent Application Publication
(10) Pub. No.: US 2015/0047865 A1
(43) Pub. Date: Feb. 19, 2015

(54) COMPLEX PNEUMATIC TOOL

(71) Applicant: ORIENT RIVER INC., Taichung City (TW)

(72) Inventor: Jen-Yung YANG, Taichung City (TW)

(73) Assignee: ORIENT RIVER INC., Taichung City (TW)

(21) Appl. No.: 14/094,026

(22) Filed: Dec. 2, 2013

(30) Foreign Application Priority Data
Aug. 13, 2013 (TW) 102215202

(51) Int. Cl. B25F 5/00; B25B 27/00

(52) U.S. Cl. CPC B25F 5/00; B25B 27/0035
USPC 173/51

(57) ABSTRACT

A complex pneumatic tool includes: a body section having a main body formed with an internal slide room; a slide member with a predetermined length, the slide member being slidably disposed in the slide room, two ends of the slide member respectively extending out of the body section from the slide room, the slide member being axially reciprocally movable between a first position and a second position under the restriction of the slide room; a first action section disposed at one end of the slide member; and a second action section disposed at the other end of the slide member. The complex pneumatic tool can be conveniently used to facilitate service operation of a vehicle.

### BACKGROUND OF THE INVENTION

1. Field of the Invention

The present invention relates generally to a vehicle service tool, and more particularly to a complex pneumatic tool.

2. Description of the Related Art

In vehicle service operation, specific worked objects necessitate specific tools. Therefore, there are various conventional service tools applicable to different worked objects. For example, Taiwanese Patent Nos. 090213560 and 090214968 disclose manually operable tools for servicing the wheel cylinder piston of a brake caliper. On the other hand, Taiwanese Patent No. 090112484 discloses a manual tool applicable to the tube binder for connecting the pipelines of a vehicle. The specific tools enable a serviceman to service the vehicle well. Also, the working time is greatly shortened and the service quality is enhanced to ensure safety in driving.

However, each of the conventional tools can only provide one single function and must be operated manually. As a result, it is inconvenient to perform the service operation.

### SUMMARY OF THE INVENTION

It is therefore a primary object of the present invention to provide a complex pneumatic tool, which can be conveniently used to facilitate service operation of a vehicle.

To achieve the above and other objects, the complex pneumatic tool of the present invention includes: a body section having a main body formed with an internal slide room; a slide member with a predetermined length, the slide member being slidably disposed in the slide room, two ends of the slide member respectively extending out of the body section from the slide room, the slide member being axially reciprocally movable between a first position and a second position under the restriction of the slide room; a first action section disposed at one end of the slide member; and a second action section disposed at the other end of the slide member.

In the above complex pneumatic tool, the slide member includes a piston slidably disposed in the slide room and an elongated slide body. A middle section of the slide body is fixedly connected with the piston. Two ends of the slide body extend out of the body section.

In the above complex pneumatic tool, the body section has an inlet passage formed in the main body, The inlet passage communicates with one end of the elongated slide room on one side of the piston.

In the above complex pneumatic tool, the first action section has a connection body outward extending from the main body. A free end of the connection body is spaced from one end of the slide member. A tube binder stretching member has a connection end. The connection end is connected with the free end of the connection body. One end of a pull cord is connected with a stretching end of the tube binder stretching member. The other end of the pull cord is connected with one end of the slide member.

In the above complex pneumatic tool, the second action section has a fixed side body separably connected with the main body in adjacency to the other end of the slide member and a movable side body separably connected with the other end of the slide member and spaced from the fixed side body. The distance between the movable side body and the fixed side body is changeable with the movement of the slide member.

In the above complex pneumatic tool, the slide member has an elongated hollow slide body. The first action section extends into the slide body from one end of the slide member.

In the above complex pneumatic tool, the first action section has an elongated rod with a predetermined length. The elongated rod extends into the slide body.

In the above complex pneumatic tool, the elongated rod is slidably connected in the slide body.

In the above complex pneumatic tool, the elongated rod is screwed in the slide body.

In the above complex pneumatic tool, the second action section further includes a duct. One end of the duct is fixedly connected to the main body and slidably connected with the slide member. The other end of the duct is engaged with the fixed side body for connecting the fixed side body to the main body.

The present invention can be best understood through the following description and accompanying drawings, wherein:

### BRIEF DESCRIPTION OF THE DRAWINGS

FIG. 1 is a perspective assembled view of a first embodiment of the present invention;

FIG. 2 is a sectional view taken along line 2-2 of FIG. 1;

FIG. 3 is a perspective exploded view of a second embodiment of the present invention;

FIG. 4 is a perspective assembled view of the second embodiment of the present invention;

FIG. 5 is a sectional view taken along line 5-5 of FIG. 4;

FIG. 6 is a side view of the second embodiment of the present invention;

FIG. 7 is a perspective exploded view of a third embodiment of the present invention;

FIG. 8 is a perspective assembled view of the third embodiment of the present invention;

FIG. 9 is a sectional view taken along line 9-9 of FIG. 8, showing that the second action section is not moved; and

FIG. 10 is a sectional view taken along line 9-9 of FIG. 8, showing that the second action section is pushed and moved.

### DETAILED DESCRIPTION OF THE PREFERRED EMBODIMENTS

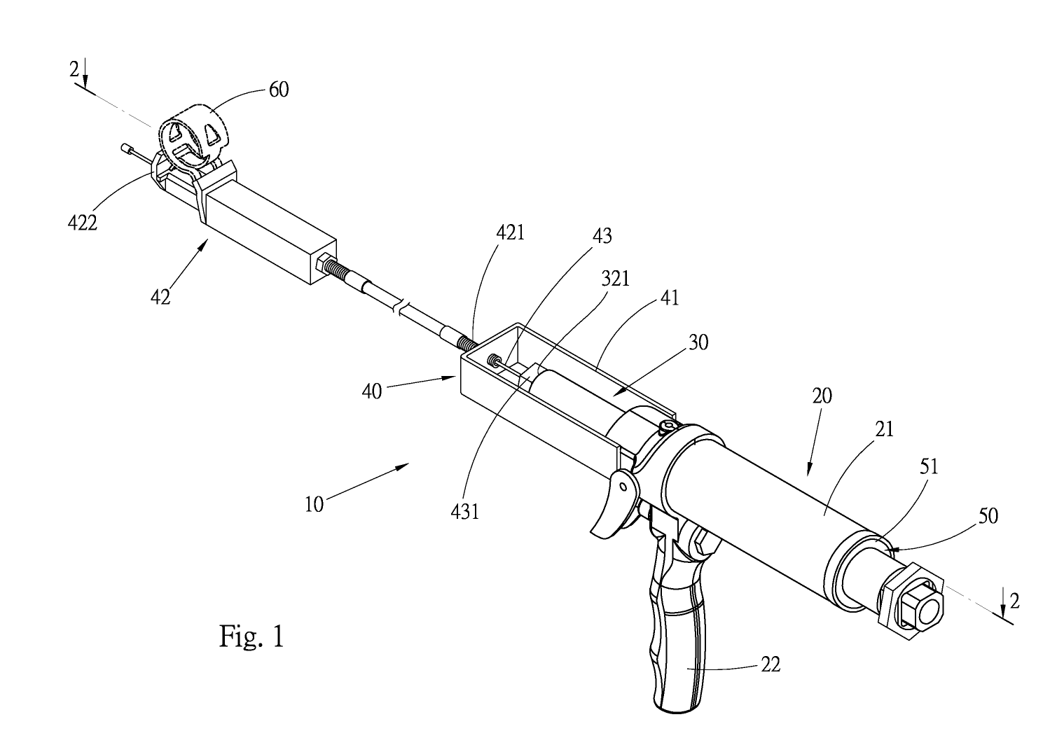

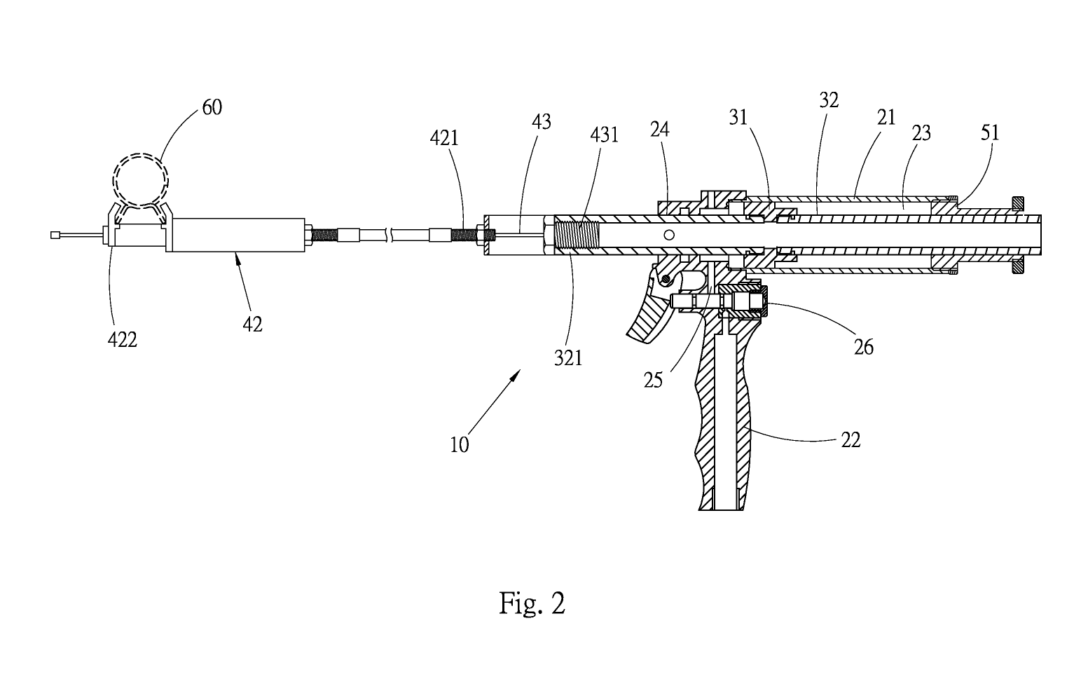

Please refer to FIGS. 1 and 2. According to a first embodiment, the usage of the complex pneumatic tool 10 of the present invention is identical to that of Patent No. 090112484. The complex pneumatic tool 10 includes a body section 20, a slide member 30, a first action section 40 and a second action section 50.

The body section 20 has a cylindrical main body 21 and a handle 22 protruding from one side of the main body 21. A substantially cylindrical slide room 23 inward extends from one end of the main body 21 along an axis of the main body 21. A slide passage 24 inward extends from the other end of the main body 21 to coaxially communicate with the slide room 23. An inlet passage 25 communicates the exterior of the handle 22 with the slide room 23. A valve member 26 is disposed on the handle 22 for controlling the unblocking/blocking of the inlet passage 25.

The slide member 30 has a piston 31 slidably disposed in the slide room 23. The piston 31 is axially reciprocally movable within the slide room 23 between a first position and a second position. The inlet passage 25 communicates with the slide room 23 in a position between the piston 31 and the slide passage 24. Accordingly, the air going inward from the exterior through the inlet passage 25 serves to push the piston 31 from the first position to the second position. A middle section of a cylindrical slide body 32 with a certain length is shafted and fixedly connected to the piston 31, whereby the slide body 32 is axially reciprocally movable along with the piston 31. Two ends of the slide body 32 respectively outward protrude from the slide room 23 and the slide passage 24.

The first action section 40 is disposed at one end of the slide body 32. The first action section 40 has a substantially U-shaped plate-like connection body 41 outward extending from the main body 21. A free end of the connection body 41 is spaced from the end 321 of the slide body 32, which end extends out of the slide passage 24. A tube binder stretching member 42 has a connection end 421 connected with the free end of the connection body 41. One end of a pull cord 43 is connected with a stretching end 422 of the tube binder stretching member 42. The other end of the pull cord 43 is fixedly connected to the end 321 of the slide body 32 via a connection bolt 431.

The second action section 50 has a duct 51 coaxially slidably connected to the other end of the slide body 32. One end of the duct 51 is fixedly connected with the main body 21 for guiding the slide body 32 to axially move between the first and second positions. Also, the second action section 50 serves as a medium for connecting the main body 21 with other components.

According to the above assembly of the complex pneumatic tool 10, the inlet passage 25 is connectable to a high-pressure air source via an external pipeline. The external air can go into the slide room 23 under control to push the piston 31 from the first position to the second position. When the piston 31 axially moves, via the pull cord 43, the stretching end 422 is driven to synchronously move. In this case, a tube binder 60 is stretched open for use. The technique of stretching open the tube binder 60 with the tube binder stretching member 42 pertains to prior art and thus will not be further described hereinafter.

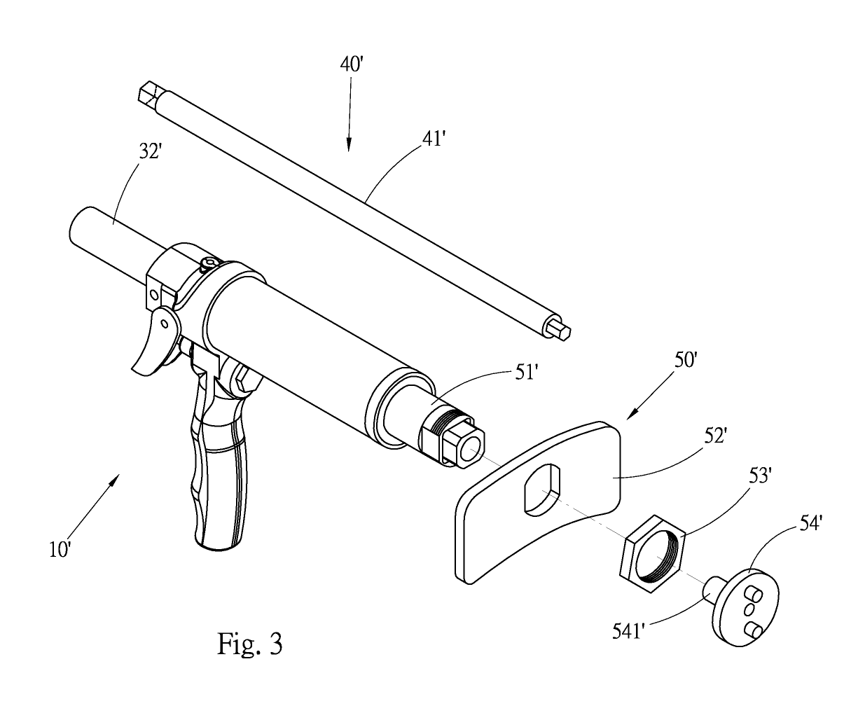

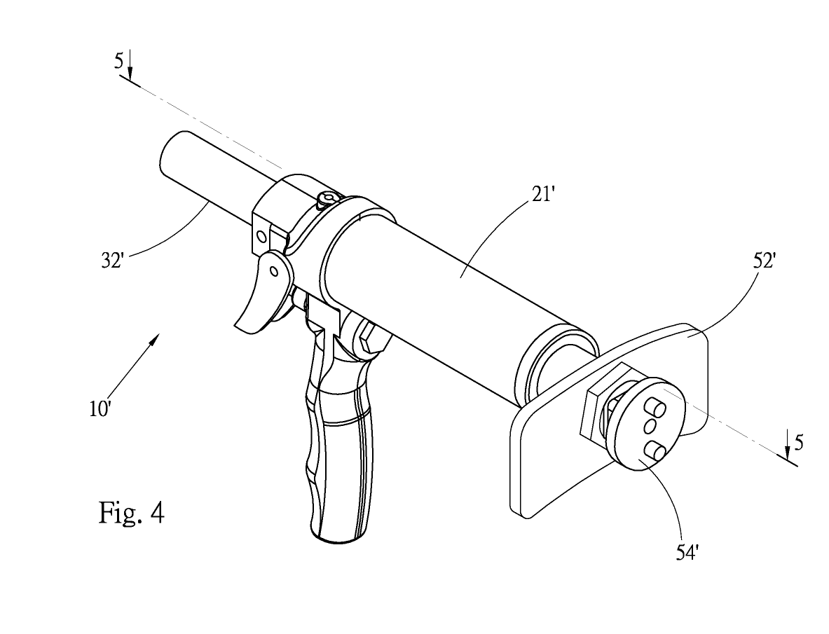

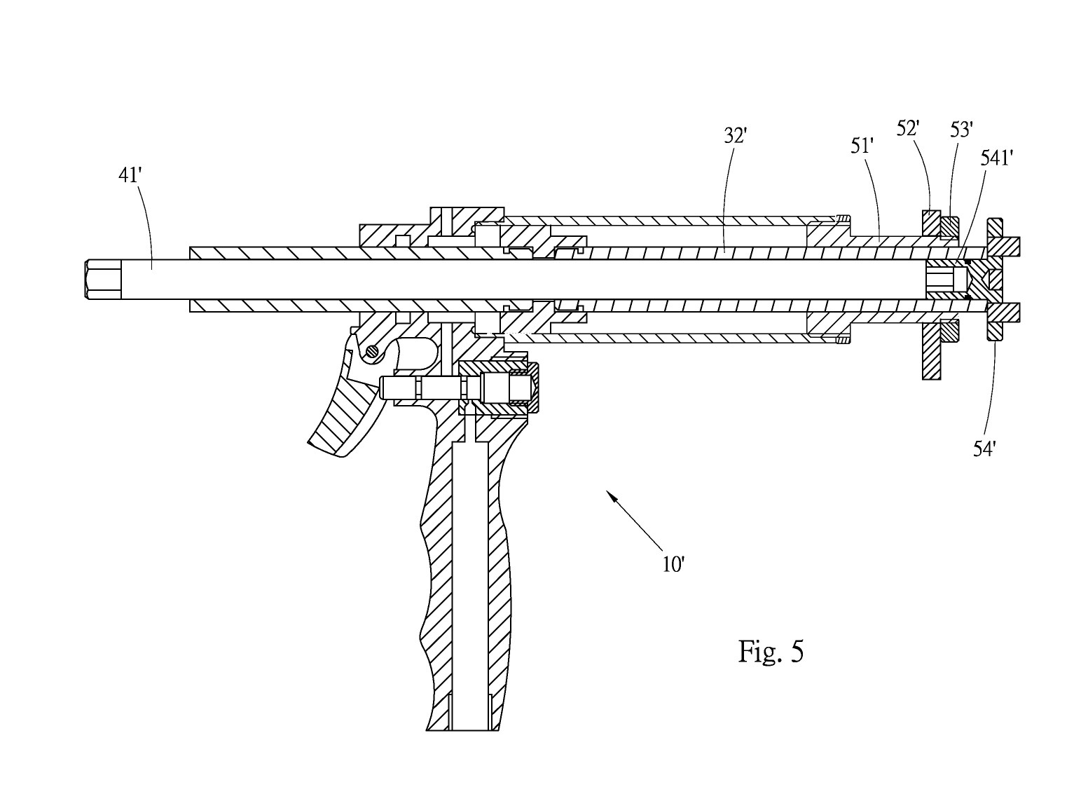

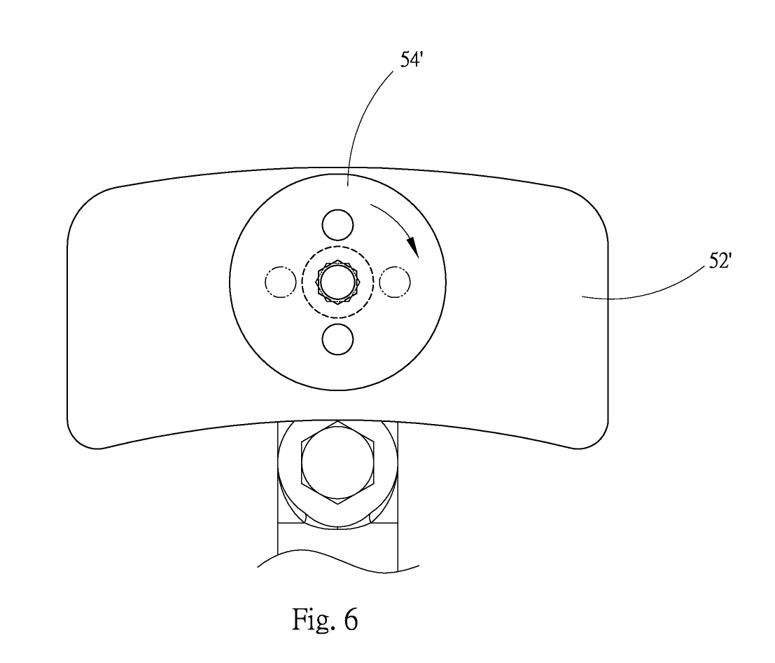

Please now refer to FIGS. 3 to 6. According to a second embodiment, the complex pneumatic tool 10′ of the present invention serves as a brake caliper service tool as Patent Nos. 090213560 and 090214968. In structure, the first action section 40′ and the second action section 50′ are different from those of the first embodiment. Also, the slide body 32′ is a hollow tubular body with two open ends.

To speak more specifically, in addition to the duct 51′, the second action section 50′ further includes a plate-like fixed side body 52′ fitted on and engaged with the other end of the duct 51′. A connection nut 53′ is screwed on the other end of the duct 51′ for locating the fixed side body 52′ on the duct 51′, whereby the fixed side body 52′ is indirectly connected to the main body 21′. A plate-like movable side body 54′ has a protruding connection post 541′ inserted in the opening of the other end of the slide body 32′

The first action section 40′ has an elongated rod 41′ with a certain length. The elongated rod 41′ coaxially extends into the slide body 32′ from one end thereof. One end of the elongated rod 41′ is engaged with the connection post 541′ of the movable side body 54′ . The other end of the elongated rod 41′ is positioned outside the opening of one end of the slide body 32′. In this case, a user can apply a force to the other end of the elongated rod 41′ to rotate the movable side body 54′ so as to meet the requirement of operation.

According to the above arrangement, in use of the complex pneumatic tool 10′, the fixed side body 52′ is attached to and leant against one side of the brake caliper, while the movable side body 54′ is leant against the wheel cylinder piston of the brake caliper. Also, the position of the movable side body 54′ is adjustable by means of the first action section 40′ so as to snugly lean the movable side body 54′ against the wheel cylinder piston of the brake caliper.

Then, the external high-pressure air goes into the slide room 23′ to push the piston 31′ from the first position to the second position so as to enlarge the relative distance between the movable side body 54′ and the fixed side body 52′ and push back the wheel cylinder piston of the brake caliper for facilitating the service operation.

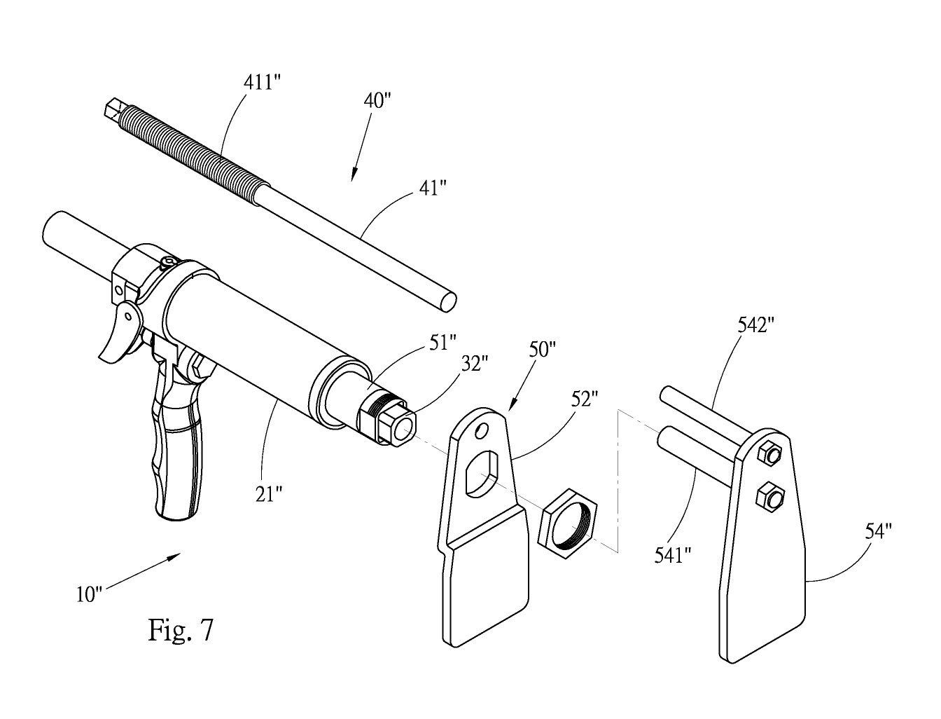

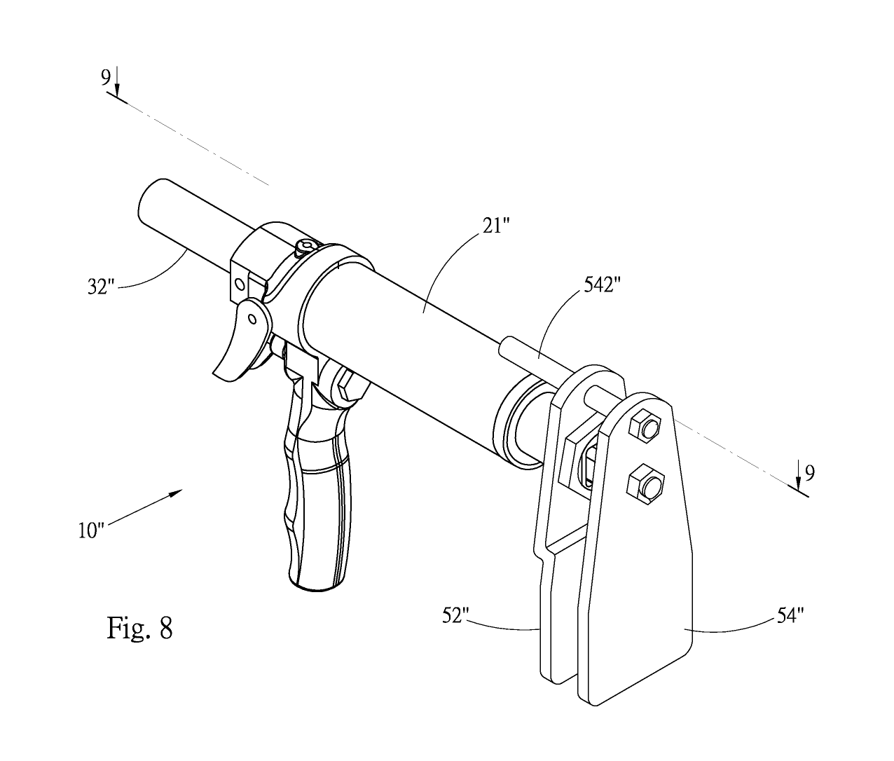

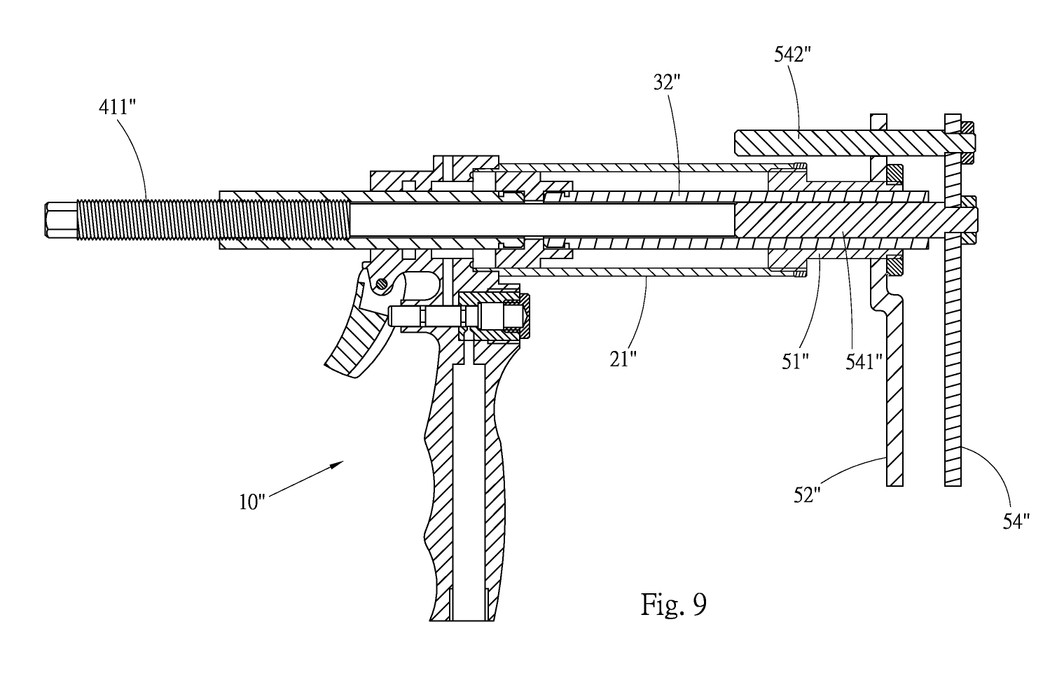

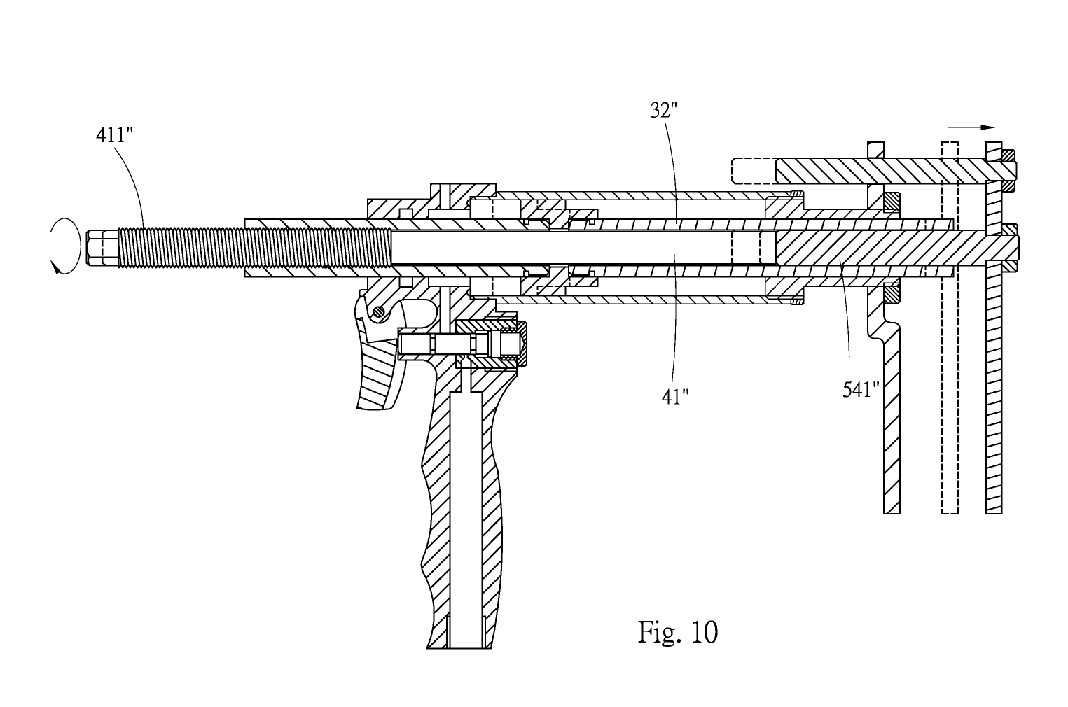

Please now refer to FIGS. 7 to 10. The third embodiment of the complex pneumatic tool 10″ of the present invention is substantially identical to the second embodiment. The third embodiment is different from the second embodiment in that the third embodiment is applicable to a brake caliper with wheel cylinder pistons on both sides. Therefore, in this embodiment, the second action section 50″ and the first action section 40″ are different from those of the second embodiment as follows:

The fixed side body 52″ and the movable side body 54″ of the second action section 50″ are similar to each other in configuration. Therefore, when the fixed side body 52″ and the movable side body 54″ are connected to the main body 21″ and the slide body 32″, the fixed side body 52″ and the movable side body 54″ serve as action ends in parallel to each other on the same side. To speak more specifically, the fixed side body 52″ is only different from the fixed side body of the second embodiment in configuration, while the fixed side body 52″ is indirectly connected to the main body 21″ via the duct 51″ by the same structure as the second embodiment. The connection post 541″ of the movable side body 54″ is slidably connected to the opening of one end of the slide body 32″. Moreover, the movable side body 54″ has a guide post 542″ slidably connected to the fixed side body 52″ for keeping the movable side body 54″ and the fixed side body 52″ aligned with each other.

The elongated rod 41″ of the first action section 40″ coaxially extends into the slide body 32″. One end of the elongated rod 41″ abuts against the connection post 541″. A section of the elongated rod 41″ is formed with a thread 411″ correspondingly screwed in a thread formed on inner wall face of the slide body 32″.

According to the above arrangement, the usage of the complex pneumatic tool 10″ is similar to that of the second embodiment. However, in this embodiment, the elongated rod 41″ is screwed in the slide body 32″ to outward push the connection post 541″ so as to enlarge the distance between the movable side body 54″ and the fixed side body 52″. Accordingly, in the case that the power of the external high-pressure air source is insufficient to move the movable side body 54″ to a desired position, a user can use the elongated rod 41″ to push the connection post 541″ so as to move the movable side body 54″ to the desired position for facilitating operation.

The above embodiments are only used to illustrate the present invention, not intended to limit the scope thereof. Many modifications of the above embodiments can be made without departing from the spirit of the present invention.

What is claimed is:

1. A complex pneumatic tool comprising:
a body section having a main body formed with an internal slide room;
a slide member with a predetermined length, the slide member being slidably disposed in the slide room, two ends of the slide member respectively extending out of the body section from the slide room, the slide member being axially reciprocally movable between a first position and a second position under the restriction of the slide room;
a first action section disposed at one end of the slide member; and
a second action section disposed at the other end of the slide member.

2. The complex pneumatic tool as claimed in claim 1, wherein the slide member includes a piston slidably disposed in the slide room and an elongated slide body, a middle section of the slide body being fixedly connected with the piston, two ends of the slide body extending out of the body section.

3. The complex pneumatic tool as claimed in claim 2, wherein the body section has an inlet passage formed in the main body, the inlet passage communicating with one end of the elongated slide room on one side of the piston.

4. The complex pneumatic tool as claimed in claim 1, wherein the first action section has a connection body outward extending from the main body, a free end of the connection body being spaced from one end of the slide member, a tube binder stretching member having a connection end, the connection end being connected with the free end of the connection body, one end of a pull cord being connected with a stretching end of the tube binder stretching member, the other end of the pull cord being connected with one end of the slide member.

5. The complex pneumatic tool as claimed in claim 1, wherein the second action section has a fixed side body separably connected with the main body in adjacency to the other end of the slide member and a movable side body separably connected with the other end of the slide member and spaced from the fixed side body, the distance between the movable side body and the fixed side body being changeable with the movement of the slide member.

6. The complex pneumatic tool as claimed in claim 5, wherein the slide member has an elongated hollow slide body, the first action section extending into the slide body from one end of the slide member.

7. The complex pneumatic tool as claimed in claim 6, wherein the first action section has an elongated rod with a predetermined length, the elongated rod extending into the slide body.

8. The complex pneumatic tool as claimed in claim 7, wherein the elongated rod is slidably connected in the slide body.

9. The complex pneumatic tool as claimed in claim 7, wherein the elongated rod is screwed in the slide body.

10. The complex pneumatic tool as claimed in claim 5, wherein the second action section further includes a duct, one end of the duct being fixedly connected to the main body and slidably connected with the slide member, the other end of the duct being engaged with the fixed side body for connecting the fixed side body to the main body.

11. The complex pneumatic tool as claimed in claim 6, wherein the second action section further includes a duct, one end of the duct being fixedly connected to the main body and slidably connected with the slide member, the other end of the duct being engaged with the fixed side body for connecting the fixed side body to the main body.

12. The complex pneumatic tool as claimed in claim 7, wherein the second action section further includes a duct, one end of the duct being fixedly connected to the main body and slidably connected with the slide member, the other end of the duct being engaged with the fixed side body for connecting the fixed side body to the main body.

13. The complex pneumatic tool as claimed in claim 8, wherein the second action section further includes a duct, one end of the duct being fixedly connected to the main body and slidably connected with the slide member, the other end of the duct being engaged with the fixed side body for connecting the fixed side body to the main body.

14. The complex pneumatic tool as claimed in claim 9, wherein the second action section further includes a duct, one end of the duct being fixedly connected to the main body and slidably connected with the slide member, the other end of the duct being engaged with the fixed side body for connecting the fixed side body to the main body.
